(19) United States
(12) Patent Application Publication
(10) Pub. No.: US 2012/0061931 A1
(43) Pub. Date: Mar. 15, 2012

(54) FENDER BRAKE ASSEMBLIES FOR SCOOTERS

(76) Inventors: Thomas Floyd, Portland, OR (US); Andrew Broussard, Vista, CA (US)

(21) Appl. No.: 12/881,060

(22) Filed: Sep. 13, 2010

(51) Int. Cl. B62L 1/04; B62K 3/00; B62L 1/02; B62K 9/00; F16M 13/02; B60L 3/04

(52) U.S. Cl. 280/87.041; 248/205.1; 188/19

(57) ABSTRACT

A fender brake assembly for a rear wheel of a scooter includes a bracket having a top plate adapted to be removably secured to a scooter deck plate proximate the rear wheel, and a pair of opposite side plates extending transversely therefrom, with the side plates each being adapted to support respective ends of a hinge pin to extend between the side plates and forward of the front edge of the top plate. A fender brake is pivotably mounted on the hinge pin, and a biasing member, such as a torsion spring, biases the fender brake toward a rest position, such as one in which an engagement surface thereof is spaced from a rear wheel surface. The fender brake assembly may be removably secured, as a unit, to the deck plate. A resilient riser may be disposed between the bracket and the deck plate.

### TECHNICAL FIELD

The disclosure relates to fender brakes for scooters, and in particular to fender brake assemblies that include a bracket adapted to be removably mounted to the underside of a scooter deck plate.

### BACKGROUND

Foot-powered scooters, also referred to as kick scooters, have enjoyed a resurgence in popularity in recent years, as a means of personal transport or recreational activity, generally for young children. Conventionally, a kick scooter includes a scooter deck supported relative to the ground by front and rear wheels, with a steering assembly typically supported on the deck and operationally coupled to the front wheel. Although many types of braking systems have been developed for use with kick scooters, a popular type is a fender brake, an example of which is shown in FIGS. 1 and 2.

As shown in FIG. 1, a scooter deck, indicated at 10, includes a deck plate 12 and a pair of reinforcing walls 14, which support both a rear wheel 16 and a fender brake member 18 positioned to extend over the wheel. The rear wheel is mounted for rotation, such as via an axle bolt 20 mounted to the reinforcing walls, and the fender brake is mounted for pivotal movement relative to the rear wheel as shown by the arrow, between a position in which the fender brake, or more particularly, an engagement portion on the inner surface thereof, engages the rear wheel (shown in dashed lines), and a position in which it does not (shown in solid lines). FIG. 2 is a rear view of the scooter deck of FIG. 1 with the rear wheel not shown, in which it can be seen that fender brake member 18 is supported on a hinge pin 22 that extends between the walls 14, and includes a torsion spring 24 positioned to bias the fender brake toward the non-engaged position. Hinge pin 20 is typically supported in bores 26 that are formed in the walls 14. In operation, a user rides the scooter in a standing position, with a “forward” foot placed on the top surface of the deck, generally closer to the front of the deck than the back, using the other (the “back” foot) to kick against the ground to provide a motive force to the scooter, or intermittently to operate the fender brake by pressing it downward to urge it into contact with the rear wheel.

As with skateboards, many users of scooters enjoy performing stunts or tricks with scooters, such as jumping one or more of the wheels of the scooter off the ground, landing a jump, performing other stunts in which only the front or rear wheel is in contact with the ground, and so forth. Many scooters, however, are not intended for such use, for example if the scooter components, such as the scooter deck, are not designed to endure the types of stress applied by trick riding. For example, in executing a jump, a rider will typically place both feet on the scooter deck while airborne, for greater stability when landing the jump, with the back foot proximate to the back end of the deck. However, forming bores 26 in the walls 14 of the scooter deck 10 shown in FIGS. 1 and 2 may substantially weaken the walls' ability to reinforce the deck plate against bending under downward force, especially at the bore. Thus, considering that even a simple stunt such as landing a jump delivers considerably more force to the portions of the deck bearing the rider's feet than from regular riding, and usually in the form of a sudden impact, the mechanical weakness introduced by a bore formed in the reinforcing wall may result in bending or breakage of the deck, especially if the bore is close to the point at which the impact force is delivered. In some cases, even the force administered to the deck during casual riding may be sufficient to bend a deck weakened by bores in the reinforcing walls.

### SUMMARY

Illustrative embodiments of a rear fender brake assembly, and a bracket adapted to support a fender brake hinge pin, are disclosed. A fender brake assembly according to this disclosure that includes such a bracket, and a fender brake pivotably mounted on the hinge pin, may be removably secured, as a unit, to the deck of a scooter adjacent a rear wheel, such as via a bolt or other fastening mechanisms to the deck plate, rather than to the reinforcing walls of the deck. Illustrative embodiments of a bracket for supporting a fender brake hinge pin in a fixed position relative to a scooter deck plate as shown and described herein include a top plate adapted to be removably secured to the deck plate proximate the rear wheel, a pair of opposite side plates extending transversely from the top plate, with the side plates each including a support portion extending forwardly therefrom and past a front edge of the top plate. The support portions are each adapted to support respective ends of the hinge pin, such as via bores formed in the inwardly facing inner surfaces thereof, so that a hinge pin thus supported extends between the support portions and forward of the front edge of the top plate. In such embodiments, the top plate may be secured to the underside of the deck plate.

Illustrative embodiments of a fender brake assembly adapted to be removably secured, as a unit, to the deck plate, may include a bracket with a top plate and two side plates extending transversely therefrom, a hinge pin supported on the side plates, a fender brake pivotably mounted on the hinge pin, and a biasing member adapted to bias the fender brake toward a rest position, such as one in which an engagement portion thereof does not contact the surface of the rear wheel. Some embodiments may further include a resilient riser adapted to fit between the top plate of the bracket and the deck plate, such as to provide a vibration damping feature. In such embodiments, the biasing member may be disposed such that one end is urged against the riser, such as through an opening in the top plate of the bracket, with the other end urged against an inner surface of the fender brake.

### BRIEF DESCRIPTION OF THE DRAWINGS

FIG. 1 shows a side view of a fender brake mounted in a conventional manner to the reinforcing walls of a scooter frame, and operation of the fender brake on a rear wheel rotatably supported on the scooter frame.

FIG. 2 shows a rear view of the conventional fender brake mount of FIG. 1, with the rear wheel not shown.

FIG. 3 shows a side view of a scooter having a fender brake assembly, including a bracket for supporting a fender brake hinge pin, in accordance with the present disclosure.

FIG. 4 shows a partial top view of the scooter of FIG. 3, with the reinforcing walls, and the bracket and hinge pin of the fender brake assembly, shown in dashed lines.

FIG. 5 shows a three-dimensional view of the bracket of the fender brake assembly of FIG. 3.

FIG. 6 shows a side elevation view of the fender brake assembly of FIG. 3.

FIG. 7 shows a three-dimensional view of an alternate embodiment of a bracket, with a partial view of a riser, in accordance with the present disclosure.

FIG. 8 shows a partial side elevation view of a fender brake assembly incorporating the bracket and riser of FIG. 7.

FIG. 9 shows a partial side elevation view of a fender brake assembly incorporating the bracket of FIG. 7 and an alternate embodiment of a riser in accordance with the present disclosure.

FIG. 10 is a partial rear view of the scooter and fender brake assembly of FIG. 3, showing the bracket mounted to the underside of the deck plate, with the rear wheel not shown.

FIG. 11 is a partial rear view of a scooter having a different internal configuration than that of the scooter of FIG. 3, showing the bracket of FIG. 3 mounted thereto.

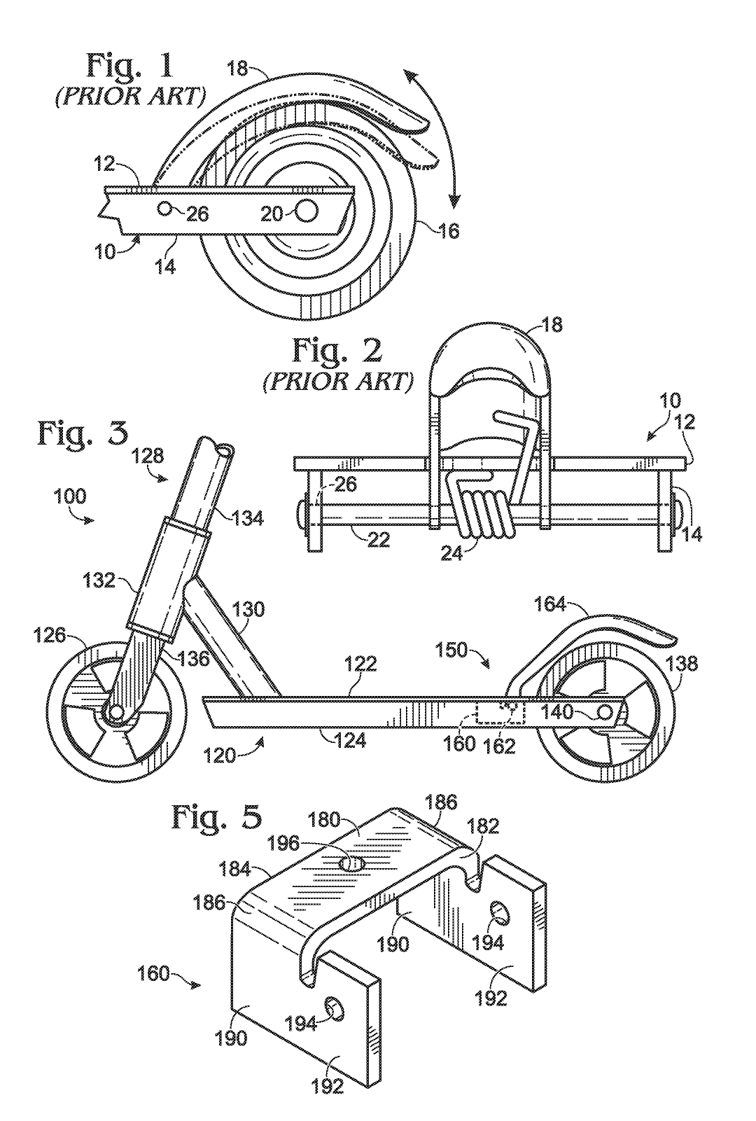

### DETAILED DESCRIPTION

FIGS. 3-11 show example embodiments of scooters incorporating fender brake assemblies, and more particularly brackets for supporting a fender brake hinge pin, constructed in accordance with aspects of the invention as set forth in the claims. More specifically, FIG. 3 shows a scooter, generally designated at 100, which includes a scooter deck 120, formed from a deck plate 122 supported by a pair of reinforcing walls 124. A front wheel 126 is mounted to a forward end of the deck, with a handlebar assembly 128 operably coupled thereto. In particular, the example scooter is shown in FIG. 3 to include a down tube 130 extending upwardly, and forwardly, from a front section of the deck, with a head tube 132 attached to the top end thereof. The handlebar assembly 128 is shown to be in the form of a fork tube 134 captured for pivotal movement in the head tube, which may include a pair of handlebars (not shown) disposed at the top end thereof, with the bottom end terminating in a fork 136 to which the front wheel is rotatably mounted. A rear wheel 138 is coupled to the rear end of the scooter deck 120 by means of an axle bolt 140, but may be mounted by any appropriate structure.

Scooter 100 also incorporates an illustrative embodiment of a rear wheel fender brake assembly, generally designated at 150 in the drawings. As shown in FIG. 3, and in greater detail in FIG. 6, rear wheel fender brake assembly 150 includes a bracket 160, a hinge pin 162 supported on the bracket, and a fender brake 164 mounted on the bracket for pivotal movement about the hinge pin. A biasing member 166, shown in FIG. 6 to be in the form of a torsion spring 168 disposed on the hinge pin, is adapted to bias the fender brake toward a desired position, such as a rest position in which it does not contact the rear wheel.

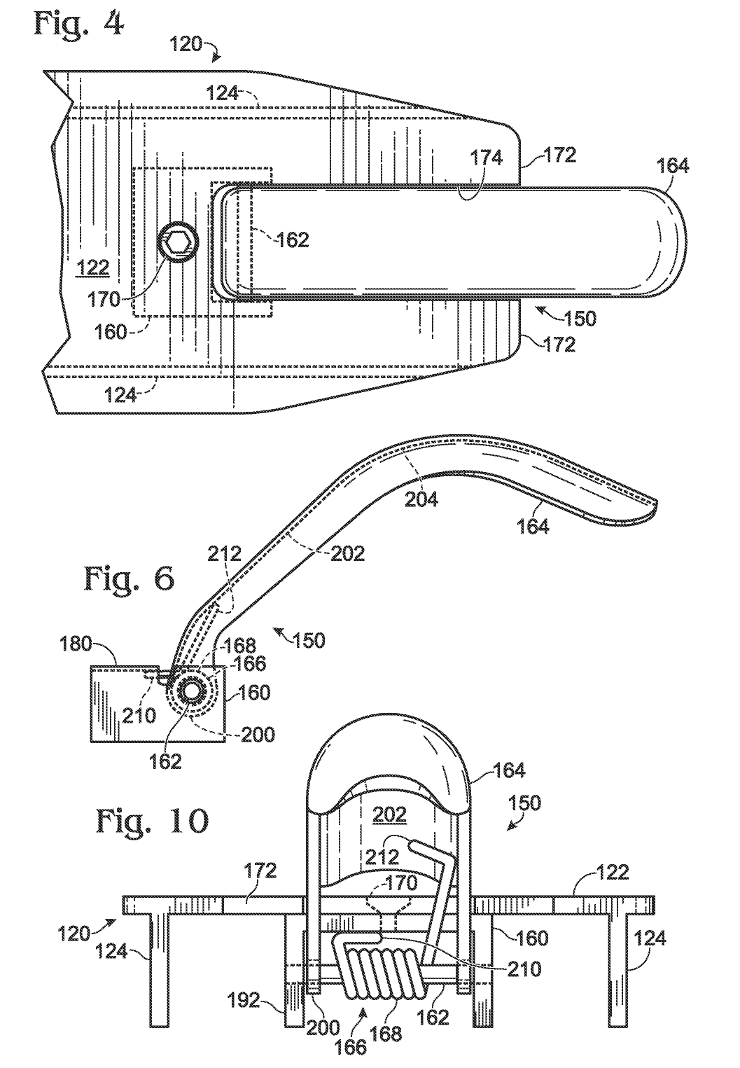

The fender brake assembly is adapted to be removably secured, as a unit, to the deck plate of a scooter, such as scooter 100, adjacent the rear wheel 138. As shown in FIG. 4, the scooter deck 120 of the example scooter 100 is shown to include two rear extensions 172 that form a channel therebetween to accommodate the portion of the rear wheel (not shown) that extends above the deck plate 122, and the fender brake 164. More particularly, the channel is defined by a generally U-shaped channel edge 174 in the rear portion of the deck plate 122, configured to provide clearance for the fender brake and/or rear wheel. Fender brake assembly is shown to be mounted to the scooter deck via bolt 170, which secures the bracket 160 to the deck plate 122. In the illustrated embodiment, the bracket is mounted to the underside, or a bottom surface of, the deck plate 122, so that the bracket sits under the deck plate 122 and between the reinforcing walls 124. As such, the fender brake assembly, and more particularly the bracket 160, is disposed to hold hinge pin 162 in a fixed position relative to the deck plate. As shown in the illustrated embodiment, the hinge pin extends across the channel, providing a pivot point for the fender brake 164, which may move up and down within the channel.

An illustrative embodiment of a bracket 160 suitable for use with the fender brake assembly 150 and scooter 100 disclosed herein is shown in FIG. 5 to include a generally flat top plate 180, which is defined by front and rear edges 182, 184, and side portions 186 that curve downward into a pair of opposing side plates 190, which extend transversely therefrom. Each side plate 190 includes a support portion 192 that extends forwardly therefrom, past the front edge 182 of top plate 180.

As shown in the illustrated embodiment, the support portions 192 are substantially coplanar with the side plates 190 from which they extend, but this configuration is not required to all embodiments. The support portions are each adapted to support respective ends of a hinge pin, such as hinge pin 162, such that when held, the hinge pin is spaced forward of the front edge 182 of the top plate 180 (see, e.g., FIGS. 4 and 6) and extends between the support portions 192.

In particular, the support portions are each shown to include a bore 194 formed in an upper portion thereof, but any suitable configuration may be used, such as a bore that does not extend through the support portion, or a short projection on which the hinge pin may be journaled, and so forth. In some examples, the bore defines threads to receive a threaded hinge pin, which may be a threaded bolt. In other examples, the bore is smooth and receives a threaded hinge pin, which is secured in a fixed position with a threaded nut.

Also, although not required to all embodiments, the side portions are shown to be parallel to each other, and to extend substantially perpendicularly from the top plate 180. Moreover, the example bracket shown in FIG. 5 is shaped from a single, flat piece of material, such as a stamped piece of sheet metal, with the side plates thereafter bent into the illustrated orientation relative to the top plate. However, other methods of fabrication may be used. For example, a bracket may be machined from a single piece of material, or may be compositely formed. In such embodiments, the top plate of the bracket, instead of having downwardly curved side portions, may instead have side edges from which the side plates extend downwardly. Moreover, although the top plate and side plates (including the support portions) of the illustrated bracket are all shown to be roughly rectangular in shape and substantially the same size as each other, such a configuration is not required, as any suitable configuration is considered to be within the scope of this disclosure.

As mentioned above and as shown in FIGS. 3, 4, and 10, the fender brake assembly is adapted to be removably secured to the deck plate of the scooter deck, rather than the reinforcing walls thereof, such as by means of a bolt 170 received in a bore 196 formed in the top plate 180 of the bracket. In some examples, the bore defines threads or includes a threaded insert for receiving a threaded bolt. However, any suitable removable fastening means, or combination of fastening means, may be used. By securing the bracket to the deck plate, rather than by supporting a hinge pin in bores formed through in the reinforcing walls, the scooter deck is not unnecessarily mechanically weakened as a consequence of mounting the fender brake.

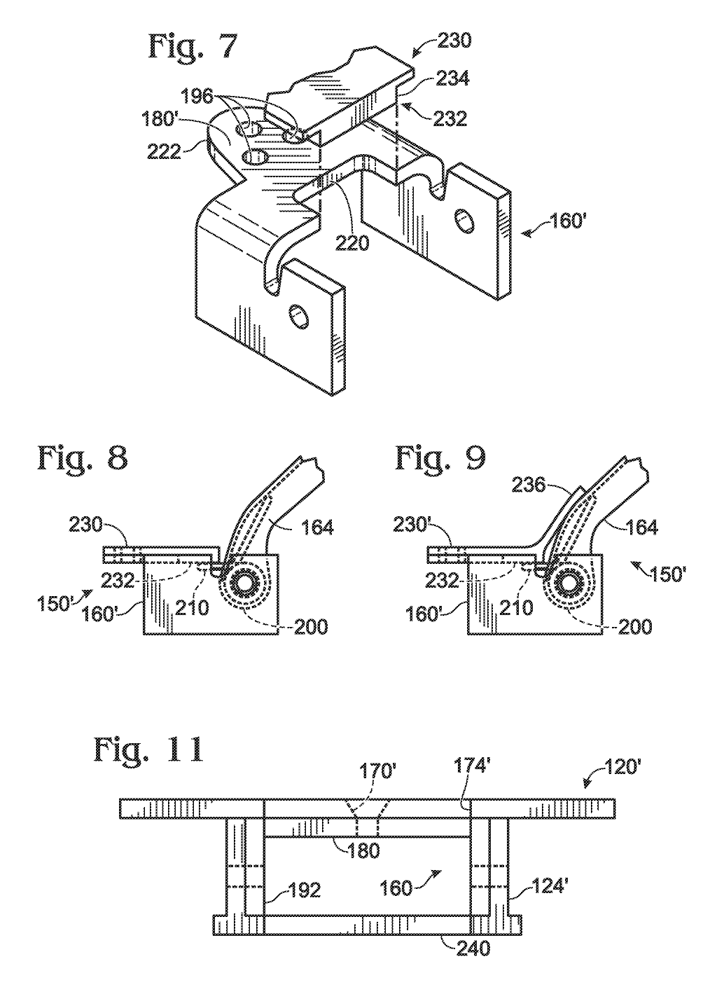

Optionally, the bracket may be secured to the deck plate at multiple locations and/or with multiple fasteners, such as one, two, three, four, six, or eight or more bolts. In some examples, such as shown in FIG. 7, the bracket is secured to the deck plate with three bolts received in three bores arranged in a triangle. In other examples, six bolts fasten the bracket to the deck plate through six bores arranged in two rows of three bores.

FIG. 6, a side view of an example embodiment of fender brake assembly 150, shows the hinge pin supported in bores 194 in the support portions 192 of the bracket 160. Fender brake 164 may be pivotably mounted on the hinge pin by any suitable manner, such as by a pair of ears 200 on a forward end thereof, through which the hinge pin extends. Fender brake 164 is shown as a rounded fender having a generally concave inner surface 202 complementary to that of a scooter wheel, which includes an engagement portion 204 adapted for selective frictional engagement with the wheel surface.

As can also be seen in FIG. 10, biasing member 166 is shown in the example embodiment of fender brake assembly 150 as torsion spring 168 coiled around the hinge pin. The biasing member 166 has a first end 210 urged against the bracket 160 (more specifically, as shown in FIGS. 6 and 10, against the underside of the top plate 180 of the bracket), and a second end urged against the inner surface 202 of the fender brake 164, and is thereby adapted to bias the fender brake generally upward into a rest position that spaces the engagement portion 204 of the fender brake from the wheel surface.

As such, the biasing member may take any suitable form, and optionally may be adjustable, such as by biasing the fender brake into any desired rest position, for example to accommodate wheels of different sizes, and/or to provide a desired amount of clearance, when in the rest position, from the wheel surface. For example, some riders might prefer a minimal amount of downward travel between the rest position and an engaged position in which the engagement portion contacts the wheel, whereas other riders might prefer a greater clearance. Also, although not required to all embodiments, the fender brake assembly 150 may be adapted to adjust the tension of the biasing member, for example to provide a desired amount of resistance against a force applied to the fender brake. Although the tension and nature of the biasing member may be adjusted by incorporating a biasing member of a desired configuration, some embodiments may allow adjustment of a single biasing member by other means.

One example of such an alternate embodiment of fender brake assembly 150, which is designated at 150′, is shown in FIGS. 7 and 8. In discussing alternate embodiments of components that are indicated herein with specific reference numbers, this disclosure uses a convention to indicate such components with a symbol following the reference number, to indicate that the alternate embodiment of the component incorporates a different physical configuration from, but embodies the same concepts of the component originally indicated with the reference number.

Thus, a bracket, indicated as 160′ (to represent that it incorporates a different physical configuration than bracket 160), is shown to include an opening 220 in the top plate 180′ near the front edge thereof, and a tab 222 extending from a rear edge in which bore 196 is formed, for example to fasten the bracket to the deck plate in the manner explained above. The alternate embodiment 150′ is also shown to include a riser 230, which includes an engagement area 232 disposed on a bottom surface thereof. In FIGS. 7 and 8, the engagement area 232 is shown as a protrusion 234 shaped to fit into the opening 220. FIG. 8 shows that when a bracket having such a configuration is incorporated into a fender brake assembly, the end of the biasing member that would otherwise rest against the top plate (such as in fender brake assembly 150 shown in FIG. 6) instead rests against the engagement area 232 that is accessible via the opening 220 in the top plate 180′.

The configuration of the engagement area 232, such as the thickness of the protrusion 234, may thus allow the tension of the biasing member to be correspondingly set; as such, selecting a riser with a desired protrusion thickness may allow a rider to adjust the tension of a given biasing member. Of course, the engagement area 232 of the riser 230 may be flush with the bottom surface thereof instead of protruding therefrom, or may even be recessed relative to the bottom surface.

Optionally, the riser 230 may be fabricated from a material having some degree of resilience, such as rubber, urethane, and so forth, which may provide a fender brake assembly incorporating such a riser to have a desired degree of resistance, and/or allow a user to adjust the resistance by selecting a riser made from a material of a certain resilience.

FIG. 9 shows a fender brake assembly 150′ that incorporates a variation of riser 230, indicated as 230′, which is shown to include an extending tab 236 that extends generally upward and rests against the outer surface of the fender brake 164. In this variation, the riser may set, or help brace, the rest position of the fender brake at a desired angle and/or distance from the wheel surface.

When installed, a fender brake assembly 150′ that includes a riser, such as riser 230, 230′, or other variations thereof, the riser is disposed between the top plate of the bracket and the underside of the deck plate. In embodiments that include a riser with an upwardly extending tab, such as riser 230′, the extending tab may protrude to some extent above the surface of the deck plate. Regardless of whether the riser is configured to include an extending tab, however, if such a riser is fabricated from a material having some degree of compressibility and/or resilience, such as rubber, urethane, and so forth, the riser may additionally provide a vibration dampening feature, for example by serving as a vibration damping layer between brake components that carry forces received from contact with a ground surface, and a rider's foot resting on the exterior surface of the fender brake. Such a feature may in turn ensure smoother brake operation by reducing vibration interference and noise.

As such, it can be seen that the physical configuration of the riser may be varied from that as shown and discussed, without departing from the scope of the disclosure, as such variations, including those incorporating the concepts and features discussed above, are intended to be within the scope of this disclosure.

FIG. 11 shows a rear elevation view of the fender brake assembly 150 (which is not shown to include a riser) installed to the scooter deck 120. Although not required to all embodiments, the support portions 192 are shown to be disposed such that the inner surfaces thereof are spaced apart from each other by a distance no greater than that sufficient to provide a clearance fit with the portion of the fender pivotably coupled to the hinge pin.

When a user presses downward on the fender brake, some of the force is borne by the hinge pin; this force is strongest at the points at which the fender brake is mounted on, and thus contacts, the hinge pin. A configuration in which the support portions are placed as close as possible, while still providing a clearance fit for movement of the fender brake relative to the wheel, may provide support against such downward forces bending the pin, by placing the support points close to the stress points. However, alternate embodiments may include support portions spaced from each other by any desired distance, such as for fender brakes of different widths, or for different reinforcing wall configurations.

For example, the reinforcing walls 124 of the example scooter deck 120 are shown to be disposed closer to the side edges of the deck plate 122 than to its longitudinal center; accordingly, an alternate embodiment of bracket 160 may include support portions spaced so that when installed to the deck plate, the outer surfaces of the support portions are closer to, or even abut, the reinforcing walls 124. Such a configuration may be suitable in applications in which additional support against inadvertent lateral movement of the bracket relative to the deck plate is desired. Thus, the bracket may be customized to a particular scooter deck, and/or fender brake, by adjusting the distance between the support portions.

Optionally, alternate embodiments may include support portions spaced to allow a clearance fit for the fender brake, and may further include spacers or other structure extending laterally from the support portions to abut the reinforcing walls or other structural components of the scooter deck, such as to restrict inadvertent lateral movement of the bracket while at the same time providing support against bending forces applied to the hinge pin. In some applications, such as those in which a scooter deck includes reinforcing walls that are positioned close to the channel in which the rear wheel sits, the bracket walls may abut the reinforcing walls while at the same time being spaced from each other by a distance no greater than that sufficient to provide a clearance fit with the fender brake.

Such a scooter deck is shown, for example, in FIG. 11, at 120′. For clarity, the rear wheel and fender brake are not shown in FIG. 11, but it can be seen that the support portions 192 of the bracket 160 abut the reinforcing walls 124′ of the scooter deck. Moreover, the scooter deck 120′ is also shown to include a bottom plate 240, with a channel similar to channel 174′ formed therein to provide clearance for the wheel, such that the end portion of the scooter forms a vertical recess in which the side portions 192 of the bracket 160 sit, restricting lateral movement thereof relative to the scooter deck. Longitudinal movement of the bracket may be restricted by means of bolt 170′, in the manner discussed above.

Of course, other scooter decks may have internal structure different than as shown, such as including a bottom deck plate, and bracing structures in addition to or instead of reinforcing walls, and so forth. As such, the bracket, or components thereof such as the bracket support portions, may be varied in physical configuration as appropriate to the scooter deck to which the fender brake assembly, or more particularly the bracket, may be mounted. All of such variations are considered to be within the scope of this disclosure.

Although the present invention has been shown and described with reference to the foregoing operational principles and illustrated examples and embodiments, it will be apparent to those skilled in the art that various changes in form and detail may be made without departing from the spirit and scope of the invention. The present invention is intended to embrace all such alternatives, modifications and variations that fall within the scope of the appended claims.

I claim:

1. A bracket for supporting a fender brake hinge pin in a fixed position relative to a deck plate of a scooter to which a front and a rear wheel are rotatably coupled, the bracket comprising:
a top plate defined by front and rear edges and adapted to be removably secured to the deck plate proximate the rear wheel; and
a pair of opposing side plates extending transversely from the top plate, the side plates each including a support portion that extends forwardly therefrom and past the front edge of the top plate; and
wherein the support portions are each adapted to support respective ends of the hinge pin.

2. The bracket of claim 1, wherein the top plate includes a bore formed therein, the bore being adapted to receive a bolt.

3. The bracket of claim 1, wherein the support portions respectively include a pair of inwardly facing inner surfaces, each inner surface having a bore formed therein, each bore being adapted to receive one end of the hinge pin.

4. The bracket of claim 3, wherein the bores are disposed on the support portions forward of the front edge of the top plate.

5. The bracket of claim 3, wherein a portion of a fender is pivotably coupled to the hinge pin, and wherein the support portions are disposed such that the inner surfaces are spaced apart from each other by a distance no greater than that providing a clearance fit with the portion of the fender pivotably coupled to the hinge pin.

6. The bracket of claim 3, wherein the support portions also respectively include a pair of outwardly facing outer surfaces, and wherein the bore formed in at least one inner surface communicates through the support portion to the outer surface.

7. The bracket of claim 1, wherein the top plate is additionally defined by side edges, and wherein the side plates extend downwardly from the side edges of the top plate.

8. The bracket of claim 1, wherein the bracket is formed from a single piece of sheet metal.

9. A scooter including the bracket of claim 1.

10. A fender brake assembly adapted to be removably secured, as a unit, to the deck plate of a scooter adjacent a rear wheel thereof, the brake assembly comprising:
a bracket that includes a top plate adapted to be removably secured to the deck plate, and two side plates extending generally transversely from the top plate;
a hinge pin supported on and extending between the side plates;
a fender brake pivotably mounted on the hinge pin, the fender brake having an engagement portion adapted for selective frictional engagement with a surface of the wheel; and
a biasing member adapted to bias the fender brake toward a rest position wherein the engagement portion does not contact the surface of the wheel.

11. The fender brake assembly of claim 10, wherein the side plates each include a support portion extending past a front edge of the top plate of the bracket, and wherein the hinge pin is supported on the support portion, such that the hinge pin is spaced forward of the front edge of the top plate.

12. The fender brake assembly of claim 10, further including a riser adapted to fit between the top plate of the bracket and the deck plate and including an engagement area, and wherein the bracket is configured so that one end of the biasing member rests against the engagement area of the riser, with the other end of the biasing member resting against the inner surface of the fender brake.

13. The fender brake assembly of claim 12, wherein at least the engagement area of the riser is resilient.

14. The fender brake assembly of claim 12, wherein the riser further includes a tab extending therefrom and disposed to rest against an outer surface of the fender brake.

15. The fender brake assembly of claim 12, wherein the bracket has an opening formed therein through which the end of the biasing member that rests against the engagement area extends.

16. The fender brake assembly of claim 15, wherein the riser includes a protrusion on which the engagement area is disposed, and wherein the protrusion extends at least partially through the opening in the bracket.

17. A scooter, comprising:
a scooter deck including a deck plate supported by a pair of side walls;
a front wheel coupled to a forward end of the deck, and a handlebar assembly operably coupled thereto;
a rear wheel coupled to a rear end of the deck;
a rear wheel fender brake assembly removably coupled to the deck and including:
a bracket disposed between the side walls and removably secured to the deck plate;
a hinge pin supported on the bracket; and
a fender brake having an engagement portion on an inner surface thereof adapted for frictional engagement with a surface of the rear wheel;
wherein the fender brake is mounted on the bracket for pivotal movement about the hinge pin between a rest position in which the engagement portion is spaced from the surface of the rear wheel and an engaged position in which the engagement portion contacts the surface of the rear wheel.

18. The scooter of claim 17, wherein the rear wheel fender brake assembly further includes a biasing member configured to bias the fender brake toward the rest position.

19. The scooter of claim 18, wherein the biasing member is a torsion spring having a first end urged against the bracket and a second end urged against the inner surface of the fender brake.

20. The scooter of claim 17, wherein the deck plate includes a lower surface from which the side walls downwardly extend, wherein the bracket further includes a pair of side plates extending downward from the top plate, and wherein the side plates abut the side walls of the deck when the bracket is secured thereto.
